(19) United States
(12) Patent Application Publication
(10) Pub. No.: US 2010/0088133 A1
(43) Pub. Date: Apr. 8, 2010

(54) SYSTEM AND METHOD FOR PROVIDING SOCIAL SERVICES FRAMEWORK

(75) Inventors: Miroslav CINA, Hanhofen (DE); Andreas JAECKLE, Heidelberg (DE); Claus STEIMER, Weingarten (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 12/333,766

(22) Filed: Dec. 12, 2008

Related U.S. Application Data
(60) Provisional application No. 61/103,163, filed on Oct. 6, 2008.

(51) Int. Cl. G06Q 10/00; G06Q 50/00

(52) U.S. Cl. 705/7

(57) ABSTRACT

Disclosed are embodiments a software architecture for benefits management. The software architecture provides a fixed software layer (e.g., program code) which defines a workflow to support benefits management at a generic level. The workflow defines a fixed, predetermined process through which an enterprise management system receives new requests for benefits, determines whether the request meets eligibility criteria and awards or rejects the benefits request. The software architecture includes a customization layer which includes a number of customization objects, each customization object adapting performance of the generic software layer to be appropriate for a specific benefits program. This software architecture minimizes cost to benefits providers because the generic software layer is common to all public benefits programs being managed by a software user. The software architecture finds ready application for a number of different benefits administration organizations, who need only provide a customization layer to define operation sufficient for their own needs.

### REFERENCE TO RELATED APPLICATION

This Application claims the benefit of U.S. Provisional Application No. 61/103163 filed Oct. 6, 2008, the entire contents of which are incorporated herein by reference.

### FIELD

The disclosed relates to a system and method for providing automated services, in particular, services that require approvals and review of status.

### BACKGROUND

Modern enterprises such as governmental organization and private businesses typically use computer systems to manage their operations. Enterprise management systems are computerized systems that define processes and protocols for various business operations. By using enterprise management systems, public and private organizations can define processes that are to be undertaken during performance of the organization's operations which can be applied uniformly among a large set of employees.

In the case of public services providers, an enterprise management system can be used to manage provision of requested services. The provision of services often requires a review of a number of criteria by the service provider as well as the application of objective standards to the criteria to determine whether a requester of the services is eligible for receipt of the services.

Often requesters of services fail to provide in a service request all of the necessary criteria for the requested service, which results in denial of the service or a decision to grant the service based on less than all of the required information, which is a subjective application of the standards for providing the requested service and can be erroneous.

In addition, certain combinations of criteria can either result in additional services or related benefits being provided to the service requester or less services and less related benefits being provided. When there are a large number of criteria that must be analyzed to determine whether services should be provided and the types of services that are to be determined, when an individual must prepare, review the results and implement the services it becomes time consuming and difficult to determine whether a requester satisfies all of the numerous criteria and to which service.

In addition, providing services to requester's who are not eligible for the services results in waste of resources. Accordingly, a more efficient and cost effective method and system for reviewing and approving the provision of services is needed.

Presently, automated submission and management of public services is well known. Every nation provides its numerous of different public services in its own manner with differing parameters and eligibility criteria. Managing these differing services and differing criteria on a large scale is difficult due to the individualized nature of providing such services.

Automating this process would be helpful, each individual country, state, county and city implements its social services in a different manner and according to a different set of rules. What is needed is an easily customizable system for insuring proper applications, confirming eligibility compliance, approval of the requested benefits and the ultimate provision of the requested benefits or service.

### BRIEF DESCRIPTION OF THE DRAWINGS

FIG. 1 is an exemplary system implementation according to an exemplary embodiment of the present invention.

FIG. 2 is a process flow diagram according to an exemplary embodiment of the present invention.

FIG. 3 illustrates the process for creating and changing a social service plan according to an exemplary embodiment of the present invention.

FIG. 4 illustrates an exemplary software architecture according to an exemplary embodiment of the present invention.

### DETAILED DESCRIPTION

Applicants have developed a system and method for providing such as customizable system suitable for use across geographic boundaries.

Embodiments of the present invention provide a software architecture for benefits management. The software architecture provides a fixed software layer (e.g., program code) which defines a workflow to support benefits management at a generic level. The workflow defines a fixed, predetermined process through which an enterprise management system receives new requests for benefits, determines whether the request meets eligibility criteria and awards or rejects the benefits request. The software architecture includes a customization layer which includes a number of customization objects, each customization object adapting performance of the generic software layer to be appropriate for a specific benefits program. This software architecture minimizes cost to benefits providers because the generic software layer is common to all public benefits programs being managed by a software user. The software architecture finds ready application for a number of different benefits administration organizations, who need only provide a customization layer to define operation sufficient for their own needs.

The process may include, via a software layer of a computer system, and responsive to a request for benefits, providing a benefits application form to a requester. The application form may be retrieved from a customization layer of the computer system. One of a plurality of customization layers is selected based on based on a type of benefits requested. The completed form received from the requester is validated. An application object is created in the computer system corresponding to the request for benefits, the application object including data extracted from the form. Data related to the requested benefits is verified by the software layer according to a verification rule set stored in the selected customization layer. The form data and item data is analyzed, by the software layer, with respect to a analysis rule set stored in the selected customization layer to determine benefits suitable for the requester. Whether the requester is eligible to receive the requested benefits is determined by the software layer with reference to a eligibility rule set stored in the selected customization layer. The eligibility determination and application object are forwarded to an approval module for analysis of the eligibility determination and the application object including the form data and verified items data according to an approval rule set associated the software layer. A service provider is notified of the approved services for the requester.

Social services are commonly provided by governmental agencies in cooperation with service providing partners, such as private food pantries, soup kitchens, government-run health facilities, or private healthcare providers. The provision of social services, or simply benefits, is typically accomplished according to a plan or overall strategy based on the status of the requestor. For example, a requester may be temporarily out of work and may need food stamps to feed his children and medical coverage for himself, his spouse and children, while another requestor may be homeless and need access to a shelter, clothing and food. These two requesters have differing status and, as a result, require different plans for coordinating the benefits provided to each. The government social services office or department formulates the social services plans for the requesters.

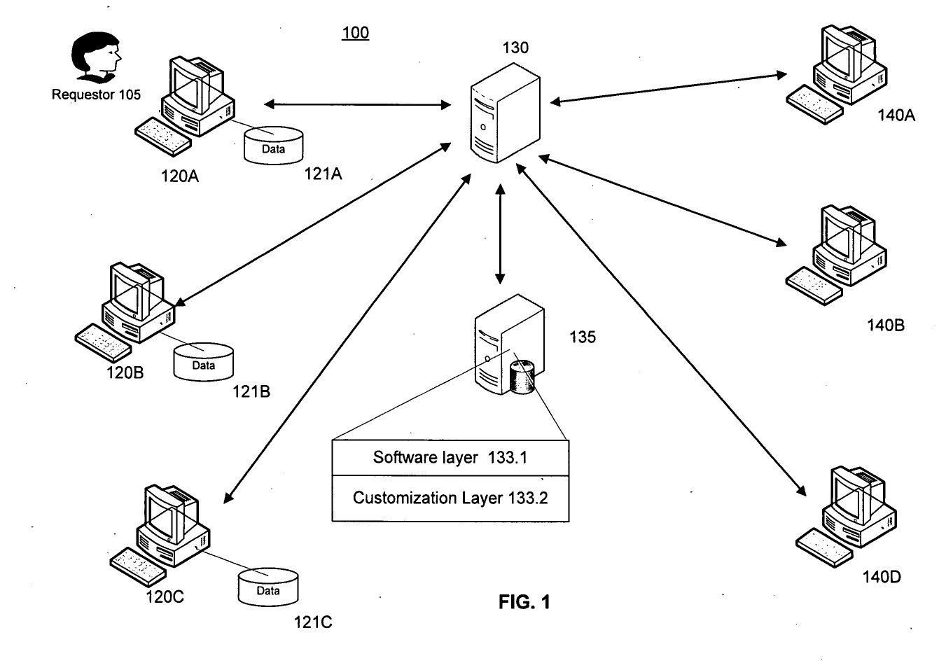

FIG. 1 illustrates an exemplary computer system for implementing a social services system. The system 100 may comprise a plurality of clients 120A-C, a server 130, a database 135, and a plurality of service partners 140A-C. Each client 120A-C may include a computer 121A-C or, simply, be a terminal connected to a server 130. The requestor 105 may provide information to the client 120A identifying the benefit(s), e.g., food stamps, meal tickets, healthcare, transportation, shelter and the like, the requestor 105 wishes to receive. According to software embodied on a computer 121A or on server 130, the social service applications may be generated based on electronic forms provided to the client 120A from either computer 121A or server 130. However, each of clients 120A-C may be located in a different jurisdictions, such as a different country, or, if in the United States, in a different state, or county within a state, all of which may have different eligibility requirements for obtaining services and different approval rules for granting approval of the requested services. Therefore, to provide the correct benefits to which the requester is entitled in the geographical region of the requester, customized rule sets may be stored at server 130. The server 130 may also communicate with a database server 135 that may also, or instead of server 130, maintain the customized rule sets applicable to the different evaluations performed in the process. Of course, the customized rule sets may be distributed between the server 130 and the database server 135.

The server 130 or the database server 135 may include a software layer 133.1 that implements a social services computer application provided by a software vendor and a customization layer 133.2 that implements customized rule sets for each jurisdiction. The customized rule sets in customization layer 133.2 may be formulated and generated using a business rule engine, hard coded, or developed in some other manner.

When the application process is completed, and the requested benefits are approved for the requestor 105, a service provider 140 may be notified by the client 120A that the requestor 105 is to receive a benefit that is provided by service provider 140A. For example, in the case of our previous hypothetical requesters, service provider 140A may provide food stamps, while service provider 140B may provide health care services, so both would be notified that requester 105 is approved to receive services.

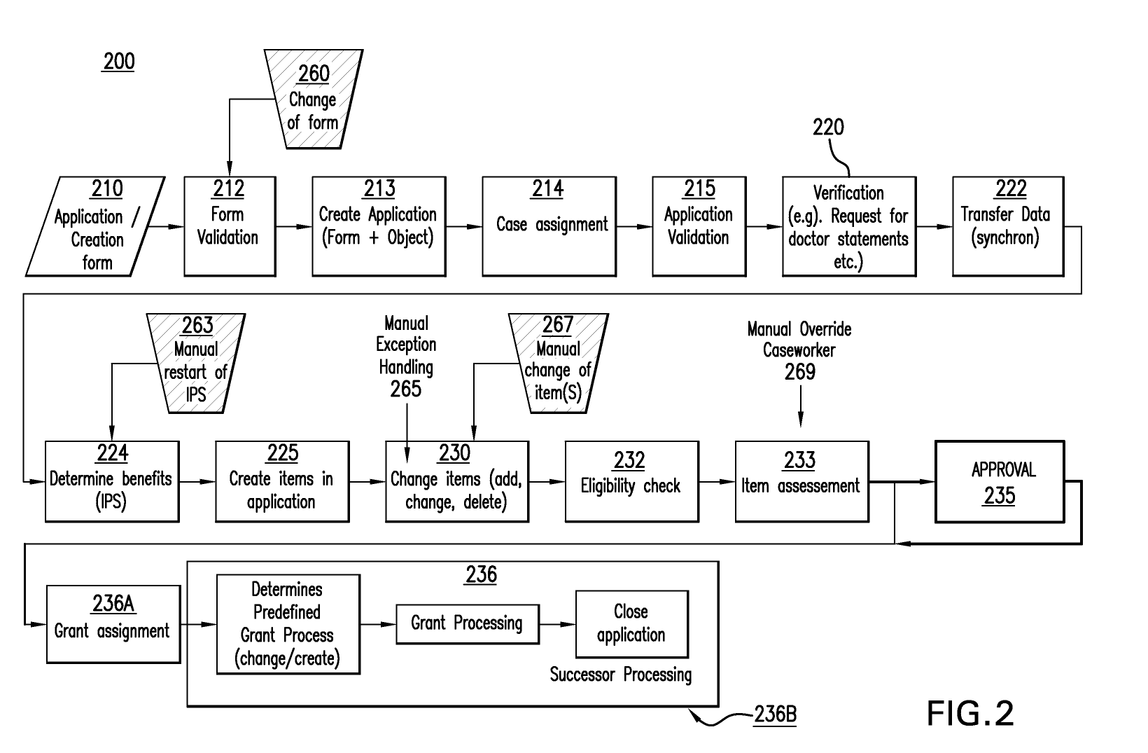

FIG. 2 illustrates a process for approving and granting benefits according to an exemplary embodiment of the present invention. The process 200 begins with the social application that is provided by a computer application having a graphical user interface. At step 210, an application is made by a requestor for services or benefits. As part of the application process, an application form is created. The application form may be an XML document. Of course, data formats other than XML may be used. The application form at 210 will require certain fields to be populated with data, such as requester name, address, benefits or services needed, and the like. The certain fields that may need to be populated may be dictated by a universal software layer associated in combination with a customized rule set that is dependent on the jurisdiction in which the requester is making the application for services. Once the form is populated with data, the application form is validated at 212 via the software layer and according to any customized rule sets stored in the customization layer by examining the form for errors. If the form validation fails at 212, for example, because the wrong form is used to request the desired services, the application form can be changed by the computer application calling a change form process 260. Upon change form process 260 changing the form, the application form is again validated at 212. Once validated, the software layer, at 213, extracts data from the application form and creates a social application computer business object (“an application object”). The application object and form data may be maintained by the software layer that can save the data in the database server 135. Once the application object is created, the application object for the requester is assigned according to a customized rule set, e.g., a case assignment rule set, at case assignment 214. The application is checked for errors at 215 by the software layer.

At 220, depending upon the services requested, the information provided by the requester during the application process 210 and 212 may be verified. A customized set of rules, i.e., a verification rule set, provided by a customization layer may indicate what information or evidence, e.g., doctor's statement, medical records, income tax statements, birth certificates and so on, may be required to be verified and the criteria for satisfactory verification of the application. Once verified, the data of the application object may be transferred and synchronized in the database by the software layer according a customized set of rules, i.e., transfer rules, stored in the customization layer at 222. The application object may be transferred to another module in the software layer that formulates an item proposal strategy (IPS), at 224, by the software the layer according to a customized set of rules, i.e., IPS rules, stored in the customization layer. The items in the item proposal strategy may represent tangible items, e.g., food stamps, rebate forms, vouchers, or reimbursement forms, having a predetermined monetary value that may be provided, or a predetermined time period over which the benefits may be provided, to the requester to receive the requested benefits or services. Based on the requested services, the software layer may provide a standard suite of items that are to be provided to the requester based on the services or benefits applied for by the requester at 225. The IPS may be populated with the standard suite by the software layer without considering all of the data in the application object. For example, the software layer may determine that the requester is requesting food stamps and has an income of X; therefore, under the standard suite of items, the requester is eligible for Y food stamps for Z months.

The IPS can also be manually restarted by a caseworker at 263 if the IPS rules unduly limit services or exceed a benefits.

Once the IPS has been set, the process transitions to 225, to creating the items of the IPS in the application object. The application object may now include the items of the IPS, the data from the application form and any forms generated to this point. At 230, the applicable customized rule set, e.g., local item rule set, may be applied to the IPS based on the application object. The local item rule set may indicate changes (add further items, delete items or modify) to the items in the IPS from the standard suite, and may make the indicated changes. At 265, an exception may be noted with respect to a particular item or items in the IPS or in the local item rule set, and the exception may be handled manually by a caseworker. Absent an exception, at 267, changes can be made to individual items or groups of items manually by a caseworker. When the IPS is finalized after 225 and 230, the application object with the form data and IPS items is reviewed to confirm whether the requester is eligible to receive the benefits and services in the IPS. The eligibility check is performed at 232 using local customized rules, e.g., eligibility rules. The local customized rules allow individual jurisdictions to decide the criteria that will be used to decide the extent of services or benefits to be provided to a requester, and any conditions that limit or extend services and benefits to a requester. These rules may be determined locally by the social services provider, and either hard coded or formulated and generated using known business rule frameworks provided by vendors, such as SAP®.

At step 233, the item assessment may be performed at the software layer, and may allow a case worker to manually override, at 269, any items that may have been denied or indicated as meeting the eligibility requirements. The caseworker at 269 may indicate that a requester, who failed the eligibility check at 232, is eligible anyway.

The approval of the application is performed at 235 by evaluating the data of the application object by the software layer. In the approval at 235, even though a requester is eligible for, say, for example, three different services or benefits, the requester may only be approved to receive only one of the three different services or benefits based on the software layer evaluation of the application object including the IPS items with respect to software layer rules.

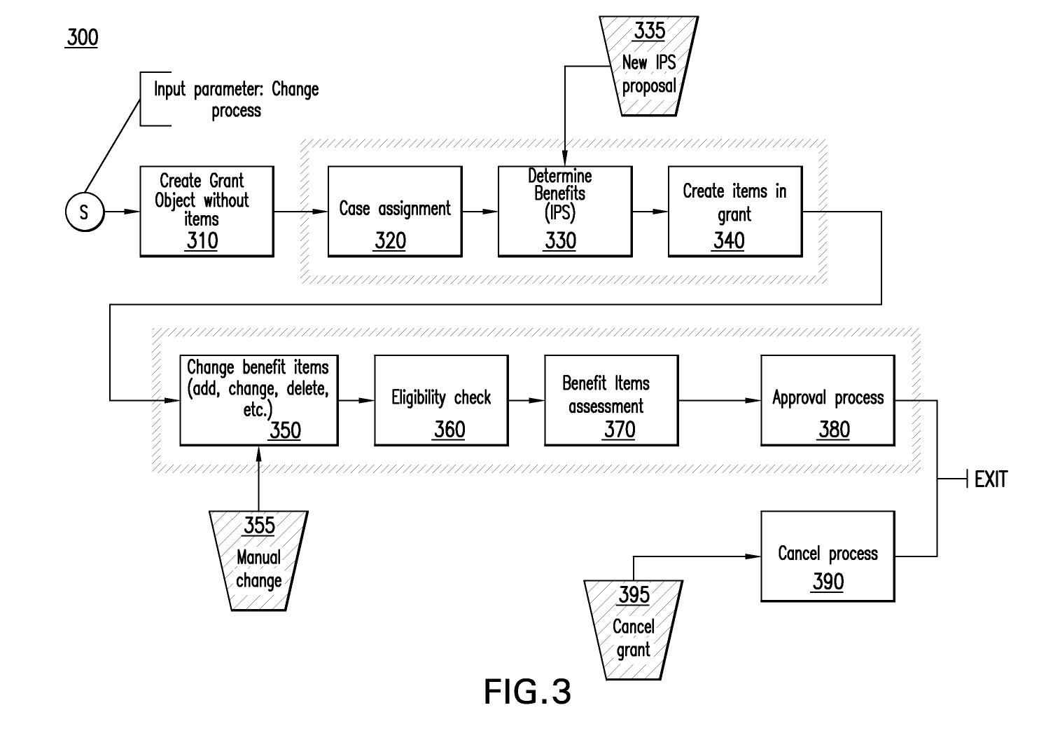

In post processing 236, the approved application is subject to plan assignment 236A and successor processing 236B. In plan assignment 236A, existing social service plan computer business objects may be evaluated to determine if any correspond to the requester for whom the benefits have been approved at 235. In response to the determination result from plan assignment 236A, the successor processing 236B may be executed by the software layer to either change the existing plan or create a new social services plan object from the approved application object. If it is determined at 236A that a plan already exists for the requester, the existing plan may be updated in 236B based on an evaluation of the social services plan object and the approved application object at 236B.1. Based on whether an existing social services plan object is to be changed or whether a new social service plan object is to be created, the approved application object is subject to grant processing 236B.2. Upon completion of grant processing 236B.2, the approved application object is closed at 236B.3, and the process exits. The successor processing 236 will now be described in more detail with reference to FIG. 3.

FIG. 3 illustrates the procedure for creating and changing a social service plan according to an exemplary embodiment of the present invention. The process 300 begins with an input parameter indicating whether a change process is being initiated or whether a new social service plan is being created. A change process can be initiated based on a new approved application for additional services or based on a change in circumstances of requester, for example, obtaining employment, birth of a child, or the like. At step 310, a grant is created without any items. The items in the grant may represent the services or benefits to be provided to the requester. As in the case assignment 214 of FIG. 2, the case assignment 320 for the requester is assigned according to a customized rule set, e.g., a case assignment rule set. These may be the same rule sets. Similarly, the item proposal strategy (IPS) is used to determine the benefits or services that are to be received by the requester at 330. A caseworker may manually propose a new IPS at 335 during the benefit determination 330. Upon determining the benefits that are to be provided to the recipient, items representing the benefits or services are created in the grant of the social services object at 334.

The process steps: change of benefit items 350, manual change 355, eligibility check 360, benefit item assessment 370, and approval process 380 may all be performed similar to steps 230, 232, 233, and 236. An exception is that manual override 269 of the item assessment 233 may not be available in benefit item assessment 370. Alternatively, the grant may also be canceled at 395, which results in the execution of cancel process 390 that cancels the grant and the resulting change of an existing social services plan object or the creation of a new social services plan object.

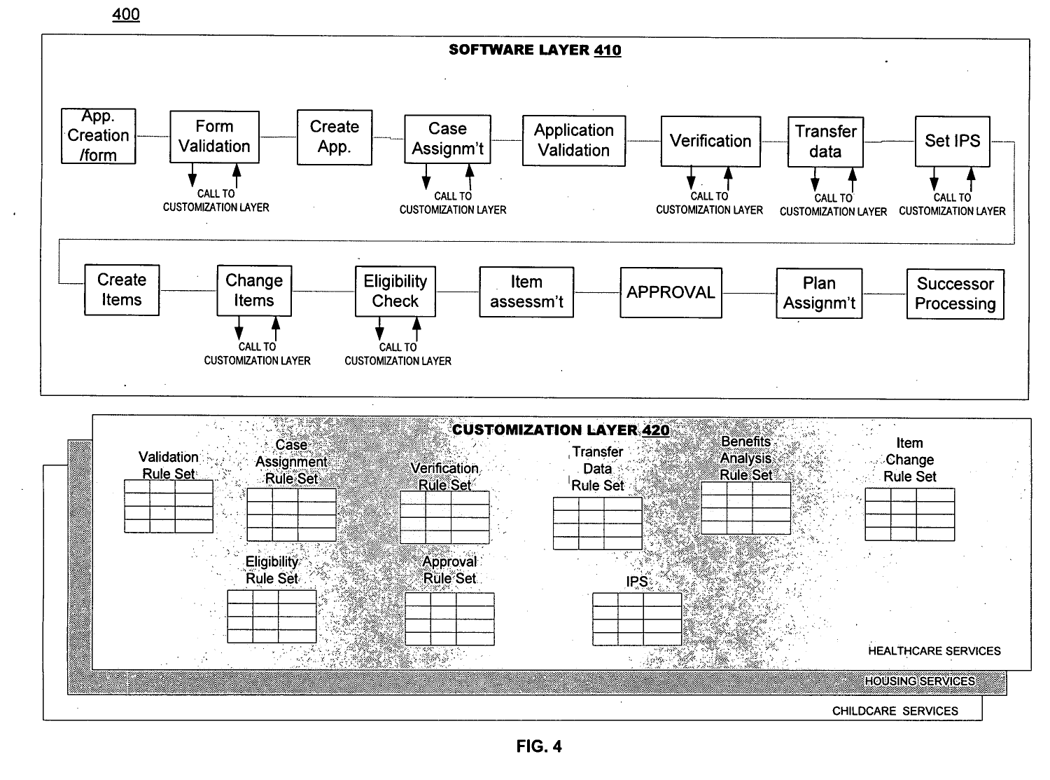

An exemplary software architecture for implementing the above described processes will now be described in more detail with reference to FIG. 4. FIG. 4 illustrates an exemplary software architecture 400. The exemplary software architecture 400 may include a software layer 410 and a customization layer 420. The software layer 410 may include basic application framework that facilitate the creation of a services application and application form through to the approval process as explained above with respect to FIG. 2. At various stages of the application process, the software layer 410 may make calls to the customization layer 420. The customization layer 420 is generated according to local rules that affect the application process. For example, rule sets can be generated for the form validation, case assignment, verification, transfer data, benefits analysis, change items, eligibility and approval of benefits. In addition, differing services, such as, for example, housing and childcare services may have customized rule sets that differ from the examples shown for healthcare. Of course, there can be a number of other services provided besides those shown.

The customization layer 420 may be developed and maintained by the end user. This allows the end user to modify any rules sets as changes occur in the criteria related to the provision of the services. In addition, as new services are provided, the end user may generate rule sets that are called by the software layer 410. The social services agency, or end user, that is accepting, processing according to the described exemplary methods, and/or approving the applications may use rule engines, as known in the computer science field and provided by vendors such as SAP® and the like, to customize the rule sets in the customization layer 420.

The exemplary software architecture and computer program instructions may be embodied on a computer readable medium such as a computer disc, optically-readable media, magnetic media, hard drives, RAID storage device, and flash memory. In addition, a server or database server may include computer readable media configured to store and execute the program instructions.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

1. A method for providing benefits from a plurality of differing service providers, comprising:
via a software layer of a computer system, responsive to a request for benefits, providing a benefits application form to a requester;
validating a completed form received from the requester,
creating an application object in the computer system corresponding to the request for benefits the application object including data extracted from the form,
verifying, by the software layer, data related to the requested benefits according to a verification rule set provided by a customization layer;
analyzing by the software layer the form data and item data with respect to an analysis rule set provided by the customization layer to determine benefits suitable for the requestor;
determining by the software layer whether the requester is eligible to receive the requested benefits, the determination made with reference to a eligibility rule set provided by the customization layer;
forwarding the eligibility determination and application object to an approval module for analysis of the eligibility determination and the application object including the form data and verified items data according to an approval rule set associated with the software layer; and
upon approval, notifying a service provider from the plurality of the differing service providers of the approved services for the requester.

2. A method for providing benefits, comprising:
via a software layer of a computer system, responsive to a request for benefits, providing a benefits application form to a requester;
based on a type of benefits requested, selecting one of a plurality of customization layers;
validating a completed form received from the requester,
creating an application object in the computer system corresponding to the request for benefits, the application object including data extracted from the form,
verifying, by the software layer, data related to the requested benefits according to a verification rule set provided by the selected customization layer;
analyzing, by the software layer, the form data and item data with respect to an analysis rule set provided by the selected customization layer to determine benefits suitable for the requestor;
determining by the software layer whether the requester is eligible to receive the requested benefits, the determination made with reference to a eligibility rule set provided by the selected customization layer;
forwarding the eligibility determination and application object to an approval module for analysis of the eligibility determination and the application object including the form data and verified items data according to an approval rule set from the plurality of rule sets associated with the customization layer; and
upon approval, notifying a service provider of the approved services for the requester.

3. A system for providing and managing social services, comprising:
a plurality of client computers; and
a server connected to the plurality of client computers, the server including a processor and a connection to a database, the processor configured to execute computer program instructions of:
via a software layer of a computer system, responsive to a request for benefits, providing a benefits application form to a requester;
based on a type of benefits requested, selecting one of a plurality of customization layers;
validating a completed form received from the requester,
creating an application object in the computer system corresponding to the request for benefits, the application object including data extracted from the form,
verifying, by the software layer, data related to the requested benefits according to a verification rule set provided by the selected customization layer;
analyzing, by the software layer, the form data and item data with respect to a an analysis rule set provided by the selected customization layer to determine benefits suitable for the requestor;
determining by the software layer whether the requester is eligible to receive the requested benefits, the determination made with reference to a eligibility rule set provided by the selected customization layer;
forwarding the eligibility determination and application object to an approval module for analysis of the eligibility determination and the application object including the form data and verified items data according to an approval rule set from the plurality of rule sets associated with the software layer; and
upon approval, notifying a service provider of the approved services for the requester.

4. A computer-readable medium embodied with program instructions for causing a computer to execute a method for providing and managing social services, the method comprising:
via a software layer of a computer system, responsive to a request for benefits, providing a benefits application form to a requester;
based on a type of benefits requested, selecting one of a plurality of customization layers;
validating a completed form received from the requester,
creating an application object in the computer system corresponding to the request for benefits, the application object including data extracted from the form,
verifying, by the software layer, data related to the requested benefits according to a verification rule set provided by the selected customization layer;
analyzing, by the software layer, the form data and item data with respect to an analysis rule set provided by the selected customization layer to determine benefits suitable for the requestor;
determining by the software layer whether the requester is eligible to receive the requested benefits, the determination made with reference to a eligibility rule set provided by the selected customization layer;
forwarding the eligibility determination and application object to an approval module for analysis of the eligibility determination and the application object including the form data and verified items data according to an approval rule set from the plurality of rule sets associated with the software layer; and
upon approval, notifying a service provider of the approved services for the requester.

5. The method of claim 1, the providing the benefits form comprises:
based on the type of benefits requested, selecting one of a plurality of customization layers for local rules that provide criteria for providing the requested type of benefits.

6. The method of claim 1, validating a completed form received from the requester comprises:
accessing a local rule set for form validation from a customization layer selected from a plurality of customization layers that provide criteria for providing the requested type of benefits.

7. The method of claim 1, verifying data comprises:
accessing a local verification rule set for verifying the data, the local verification rule set provided by the customization layer, wherein the customization layer selected from a plurality of customization layers that provide criteria for providing the requested type of benefits.

8. The method of claim 2, validating a completed form received from the requester comprises:
accessing a local rule set for form validation from the selected customization layer.

9. The method of claim 2, verifying data comprises:
accessing a local verification rule set for verifying the data from the selected customization layer.

10. The system of claim 3, further comprising:
the processor configured to:
allow modifications to local rule sets of the customization layer.
